(19) United States
(12) Patent Application Publication
(10) Pub. No.: US 2022/0286961 A1
(43) Pub. Date: Sep. 8, 2022

(54) CONTROL METHOD BASED ON UE-AIDING INFORMATION

(71) Applicant: MEDIATEK INC., Hsinchu City (TW)

(72) Inventors: Chiao-Chih CHANG, Hsinchu City (TW); Jianwei ZHANG, Beijing (CN); Nien-En WU, Hsinchu City (TW); Chih-Yuan TSAI, Hsinchu City (TW); Tsung-Ming LEE, Hsinchu City (TW); Jun-Jie SU, Hsinchu City (TW)

(21) Appl. No.: 17/686,758

(22) Filed: Mar. 4, 2022

Related U.S. Application Data
(60) Provisional application No. 63/156,390, filed on Mar. 4, 2021.

(30) Foreign Application Priority Data
Mar. 2, 2022 (CN) 202210199341.0

(51) Int. Cl. H04W 52/02; H04W 36/00

(52) U.S. Cl. CPC H04W 52/0212; H04W 36/0066

(57) ABSTRACT

A method applied to a base station includes receiving UE-aiding information that includes a power consumption requirement of the UE; and configuring one or more transmission parameters to the UE based on the UE-aiding information. The transmission parameters may include at least one of the number of antennas, the number of component carriers, a transmission bandwidth, a modulation scheme, a scheduling request period, and a radio access technology (RAT).

### CROSS REFERENCE TO RELATED APPLICATIONS

This application claims the benefit of U.S. Provisional Application No. 63/156,390, filed on Mar. 4, 2021, and China Patent Application No. 202210199341.0, filed on Mar. 2, 2022, the entirety of which is/are incorporated by reference herein.

### BACKGROUND OF THE INVENTION

### Field of the Invention

The present invention relates to a control method for power saving, and, in particular, to the control method based on UE-aiding information.

### Description of the Related Art

In current communication systems, it is the role of the base station to configure user equipment (UE) by control-signaling based on the channel status between the base station and the UE. In one example, the base station may determine the configuration through artificial intelligence big data in the communication system. However, the base station does not know whether the configuration can meet requirements when the UE executes an application.

That is, only the UE knows its own application requirements. Therefore, how to determine configuration based on what application the UE is executing has become an important topic.

### BRIEF SUMMARY OF THE INVENTION

An embodiment of the present invention provides a method based on UE-aiding information. The method is applied to a base station. The method includes receiving the UE-aiding information from a user equipment (UE) and configuring one or more transmission parameters to the UE based on the UE-aiding information. The UE-aiding information includes a power consumption requirement of at least one application currently executed by the UE.

According to the method described above, the power consumption requirement includes at least one of a data rate requirement and a latency requirement.

According to the method described above, the data rate requirement is represented by the ranking of multiple levels of the data rate requirement, and the latency requirement is represented by the ranking of multiple levels of the latency requirement.

According to the method described above, the one or more transmission parameters include at least one of: the number of antennas used for Multi-input Multi-output (MIMO), the number of component carriers, a transmission bandwidth, a modulation scheme, a scheduling request period, and a radio access technology (RAT).

According to the method described above, the method further includes sending a requirement-query message to the UE. The UE-aiding information is transmitted by the UE in response to the requirement-query message.

According to the method described above, the step of configuring the one or more transmission parameters to the UE based on the UE-aiding information includes determining the one or more transmission parameters for the UE based on the UE-aiding information; and configuring the one or more transmission parameters to the UE.

According to the method described above, the power consumption requirement includes a data rate requirement and a latency requirement and the step of determining the one or more transmission parameters for the UE based on the UE-aiding information includes: determining a first value for a transmission parameter based on the data rate requirement; determining a second value for the transmission parameter based on the latency requirement; and selecting one of the first value and the second value for the transmission parameter fulfilling both the data rate requirement and the latency requirement as a value of the transmission parameter for the UE.

According to the method described above, the method further includes detecting if a current cell where the UE is located supports the one or more transmission parameters determined based on the UE-aiding information.

According to the method described above, the method further includes detecting if there is a neighbor cell supporting a preferred RAT than the current cell where the UE is located if the current cell where the UE is located is detected as supporting the one or more transmission parameters determined based on the UE-aiding information; and asking the UE to handover to the neighbor cell based on the neighbor cell supporting being detected as supporting the preferred RAT, wherein the neighbor cell supports the one or more determined transmission parameters.

An embodiment of the present invention also provides a method applied to a user equipment (UE). The method includes transmitting UE-aiding information to a base station, wherein the UE-aiding information comprises a power consumption requirement of the UE; receiving one or more transmission parameters from the base station, wherein the transmission parameter is configured by the base station based on the UE-aiding information; and configuring the UE according to the one or more transmission parameters.

According to the method described above, the method further includes determining the power consumption requirement of the UE based on one or more power consumption requirement of one or more applications currently executed on the UE.

An embodiment of the present invention also provides a user equipment (UE). The UE includes a modem and a processor. The modem is configured to transmit UE-aiding information to a base station, wherein the UE-aiding information comprises a power consumption requirement of the UE, and receive one or more transmission parameters from the base station, wherein the transmission parameter is configured by the base station based on the UE-aiding information. The processor is configured to configure the UE according to the one or more transmission parameters.

According to the UE described above, the processor determines the power consumption requirement of the UE based on one or more power consumption requirement of one or more applications currently executed on the UE.

### BRIEF DESCRIPTION OF THE DRAWINGS

The present invention can be more fully understood by reading the subsequent detailed description and examples with references made to the accompanying drawings, wherein:

FIG. 1 is a flowchart of a control method applied to a base station based on UE-aiding information in accordance with some embodiments of the present invention.

FIG. 2 is a detail flowchart of a control method applied to the base station based on UE-aiding information in accordance with some embodiments of the present invention.

FIG. 3 is a schematic diagram of an operation of the base station for optimizing power consumption by application scenarios detection in accordance with some embodiments of the present invention.

FIG. 4 is a flow chart of a control method applied to UE to generate UE-aiding information in accordance with some embodiments of the present invention.

FIG. 5 is a schematic diagram of an operation of the UE for optimizing power consumption by application scenarios detection in accordance with some embodiments of the present invention.

FIG. 6 is a schematic diagram of reducing the number of active component carriers and reducing an active bandwidth by the control method in FIGS. 1, 2, and 4 in accordance with some embodiments of the present invention.

FIG. 7 is a schematic diagram of moving UE closed to cell boundary to another cell by the control method in FIG. 2 in accordance with some embodiments of the present invention.

FIG. 8 is a schematic diagram of configuring the transmission parameter to the UE based on the UE-aiding information by the control method in FIGS. 1, 2 and 4 in accordance with some embodiments of the present invention.

FIG. 9 is a block diagram of a communication system 900 applying the control method in FIGS. 1, 2 and 4 in accordance with some embodiments of the present invention.

### DETAILED DESCRIPTION OF THE INVENTION

The following description is made for the purpose of illustrating the general principles of the invention and should not be taken in a limiting sense. The scope of the invention is best determined by reference to the appended claims.

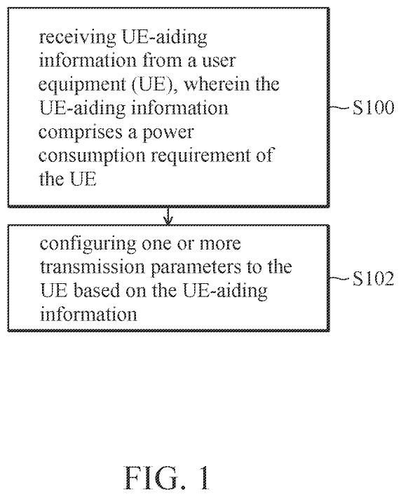

FIG. 1 is a flowchart of a control method applied to a base station based on UE-aiding information in accordance with some embodiments of the present invention. As shown in FIG. 1, the control method based on UE-aiding information includes: receiving UE-aiding information from user equipment (UE), the UE-aiding information may include a power consumption requirement of at least one application currently executed by the UE (step S100); and configuring one or more transmission parameters to the UE based on the UE-aiding information (step S102). In step S100, the application may be a messenger, gaming, cloud gaming, a 240p video conference, a 720p video streaming, or a 4K video streaming. In some embodiments, in step S102, the transmission parameters may include at least one of the number of antennas used for Multi-input Multi-output (MIMO), the number of component carriers, the transmission bandwidth, the modulation scheme, the scheduling request period, and a radio access technology (RAT). In some embodiments, the above-mentioned transmission bandwidth is defined as an RF bandwidth of an instantaneous transmission from a UE.

In some embodiments, the power consumption requirement includes at least one of a data rate requirement and a latency requirement. The data rate requirement is represented by the ranking of multiple levels of the data rate requirement, and the latency requirement is represented by the ranking of multiple levels of the latency requirement. For example, the data rate requirement can be represented by multiple levels (for example, 3 levels), such as “data rate 1st”, “balance”, and “low power 1st”. The latency requirement can be represented by multiple levels (for example, 3 levels), such as “low latency 1st”, “balance”, and “low power first”. The present invention is not limited to the number of levels of data rate requirement and latency requirement.

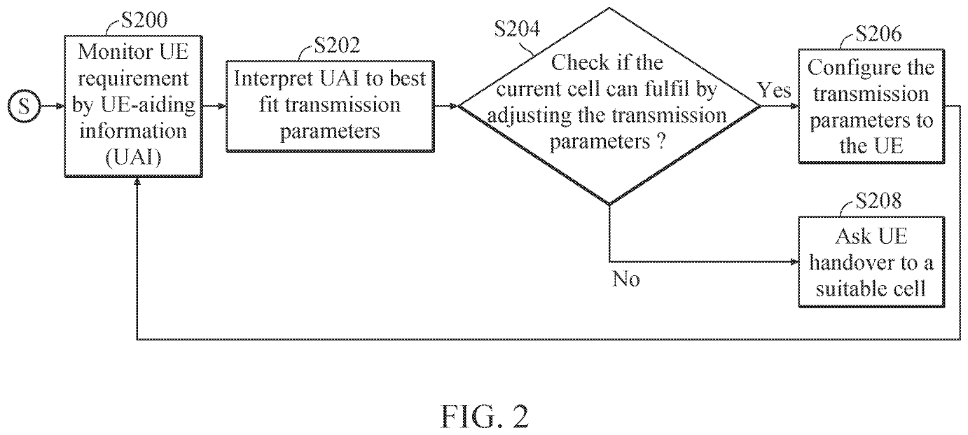

FIG. 2 is a detail flowchart of a control method applied to the base station based on UE-aiding information in accordance with some embodiments of the present invention. As shown in FIG. 2, the control method based on the UE-aiding information includes receiving and monitoring the UE-aiding information (UAI) from the UE (step S200); interpreting the UAI to best fit transmission parameters (step S202); checking if a current cell where the UE is located can fulfil the power consumption requirement by adjusting the transmission parameter (step S204); if the current cell fulfils the power consumption requirement, the base station configures the transmission parameter to the UE (step S206); and if the current cell does not fulfil the power consumption requirement, the base station asks the UE to handover to another suitable cell (step S208). In some embodiments, when the step S206 is completed, the control method of the present invention in FIG. 2 may return to step S200.

In some embodiments of step S202, the base station determines one or more transmission parameters for the UE based on the UE-aiding information. In detail, the base station determines a first value for a transmission parameter based on the data rate requirement, determines a second value for the transmission parameter based on the latency requirement, and selecting one of the first value and the second value for the transmission parameter fulfilling both the data rate requirement and the latency requirement as a value of the transmission parameter for the UE. In some embodiments of step S204, the base station detects if a current cell where the UE is located supports the one or more transmission parameters determined based on the UE-aiding information. In some embodiments of step S208, the base station asks the UE to handover to another cell supporting the one or more determined transmission parameters determined based on the UE-aiding information.

In some embodiments, the base station also detects if there is a neighbor cell supporting a preferred RAT than the current cell where the UE is located of the current cell where the UE is located is detected as supporting the one or more transmission parameters determined based on the UE-aiding information. In some embodiments, the base station asks the UE to handover to the neighbor cell based on the neighbor cell being detected as supporting the preferred RAT, wherein the neighbor cells supports the one or more determined transmission parameters.

Table 1 shows best-fit configurations in general to optimize different applications.

TABLE 1

| | Data Rate | Latency | Power | Suitable |
|---|---|---|---|---|
| Application | Requirement | Requirement | Consumption | Cell |
| Messenger | Low data rate | Not sensitive | Low power first | <10 MHz |
| | (<1 Mbps) | | | Bandwidth, |
| | | | | 5G or 3/4G |
| Gaming | Low data rate | Sensitive, <70~100 | Low power after | <=20 MHz |
| | (<1 Mbps) | ms per round trip | considering | Bandwidth, |
| | | | latency and data | 5G or 4G, |
| | | | rate | low SR |
| | | | | period cell, |
| | | | | higher data |
| | | | | priority |
| Cloud | High data rate | Sensitive, <70~100 | Low power after | 100 MHz |
| Gaming | (~25 Mbps) | ms per round trip | considering | Bandwidth, |
| | | | latency and data | 5G, low SR |
| | | | rate | period cell, |
| | | | | higher data |
| | | | | priority |
| 240p video | Low data rate | Sensitive | Low power after | <=20 MHz |
| conference | (<1 Mbps) | | considering | Bandwidth, |
| | | | latency and data | 5G or 4G, |
| | | | rate | higher data |
| | | | | priority |
| 720p video | Mid data rate | Not sensitive | Low power after | 20~100 |
| streaming | (<5 Mbps) | | considering | MHz |
| | | | latency and data | Bandwidth, |
| | | | rate | 5G |
| 4K video | High data rate | Not sensitive | Low power after | 100 MHz |
| streaming | (~25 Mbps) | | considering | Bandwidth, |
| | | | latency and data | 5G |
| | | | rate | |

Table 2 shows an embodiment of interpretation. The base station can decide transmission configuration based on UAI from the UE.

TABLE 2

| Data rate | Latency | Best-fit modem transmission |
|---|---|---|
| requirement | requirement | configuration |
| Data rate 1st | | 5G cell necessary, |
| | | component carrier (CC) >= 2, |
| | | 100 MHz BW, MIMO = 4, |
| | | 1024QAM |
| Balance | | CC = 1, 20 MHz BW |
| | | MIMO = 4, 1024QAM |
| Low power 1st | | CC = 1, <=20 MHz BW, |
| | | MIMO = 2, <=256QAM |
| | Low latency 1st | 5G cell necessary, low |
| | | scheduling request (SR) |
| | | period, higher data priority |
| | Balance | 5G cell preferred |
| | Low power 1st | Accept 4G/5G cell |

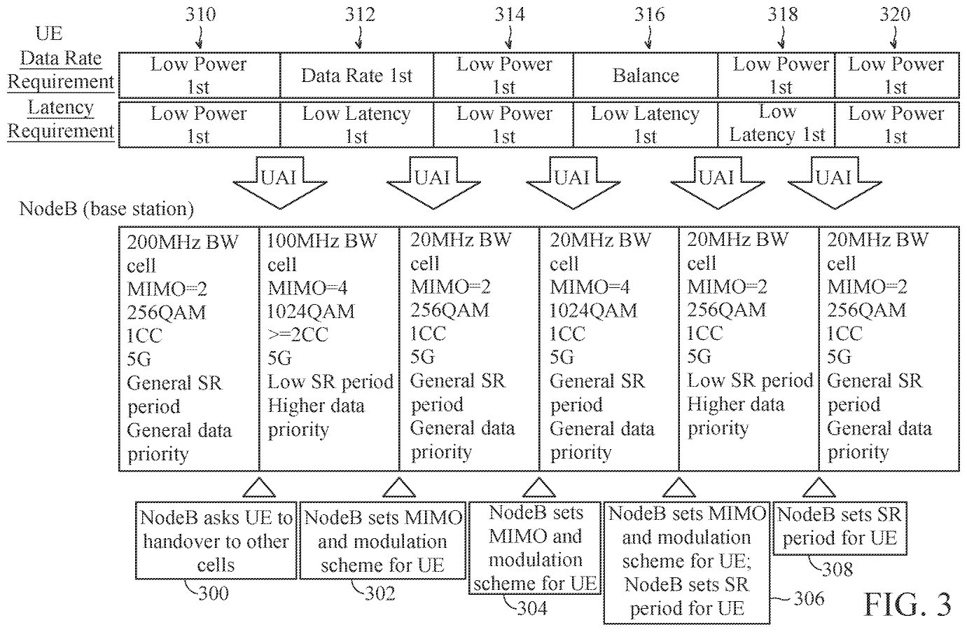

FIG. 3 is a schematic diagram of an operation of the base station for optimizing power consumption by application scenarios detection in accordance with some embodiments of the present invention. In a scenario 310, after receiving the UAI including “low power 1st” in data rate requirement and “low power 1st” in latency requirement from the UE, the base station remains the UE to stay in the current cell having 20 MHz band width, 2 active MIMO antennas, 1 active component carrier, general SR period and general data priority, and supporting 5G. In scenario 312, after receiving the UAI including “data rate 1st” in data rate requirement and “low latency 1st” in latency requirement from the UE, the base station finds the current cell cannot support and is able to execute an operation 300, that is, to ask the UE to handover to suitable cell having 100 MHz bandwidth, 1024QAM, 4 active MIMO antennas, more than 2 active component carriers, low SR period, and higher data rate priority, and supporting 5G. In a scenario 314, after receiving the UAI including “low power 1st” in data rate requirement and “low power 1st” in latency requirement from the UE, the base station is able to execution an operation 302 to set the number of active MIMO antennas and the modulation scheme for UE. For example, the base station configures the current cell as an updated cell having 20 MHz bandwidth, 2 active MIMO antennas, 256QAM, 1 active component carrier, general SR period, and general data priority, and supporting 5G.

In scenario 316, after receiving the UAI including “balance” in data rate requirement and “low power 1st” in latency requirement from the UE, the base station is able to execute an operation 304 to set the number of active MIMO antennas and the modulation scheme for UE. For example, the base station configures the current cell as an updated cell having 20 MHz bandwidth, 4 active MIMO antennas, 1024QAM, 1 active component carrier, general SR period, and general data priority, and supporting 5G. In scenario 318, after receiving the UAI including “low power 1st” in data rate requirement and “low latency 1st” in latency requirement from the UE, the base station is able to execute an operation 306 to set the number of active MIMO antennas, the modulation scheme for UE, and SR period for UE. For example, the base station configures the current cell as an updated cell having 20 MHz bandwidth, 2 active MIMO antennas, 256QAM, 1 active component carrier, low SR period, and higher data priority, and supporting 5G. In scenario 320, after receiving the UAI including “low power 1st” in data rate requirement and “low power 1st” in latency requirement from the UE, the base station is able to execute an operation 308 to set SR period for UE. For example, the base station configures the current cell as an updated cell having 20 MHz bandwidth, 2 active MIMO antennas, 256QAM, 1 active component carrier, general SR period, and general data priority, and supporting 5G.

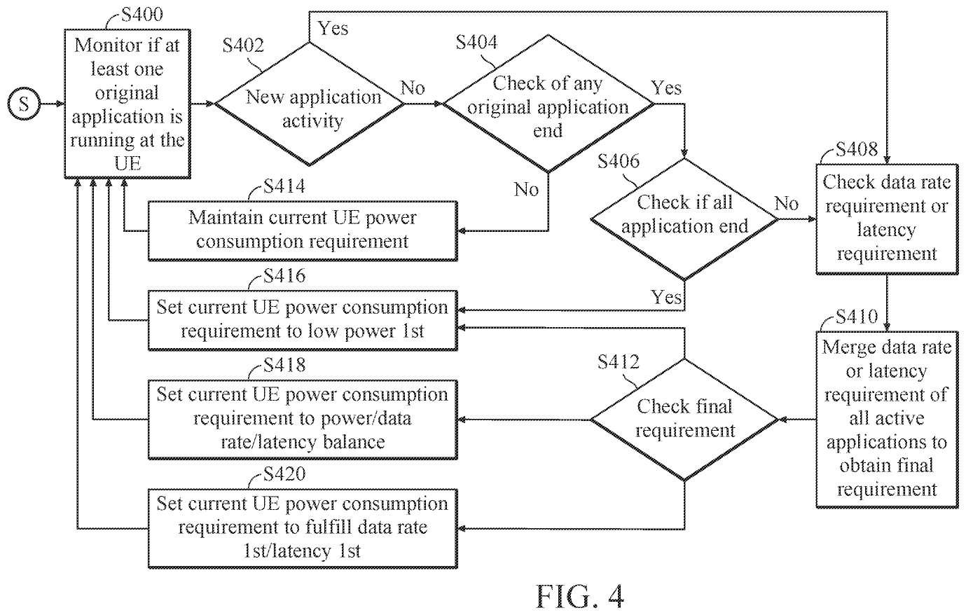

FIG. 4 is a flow chart of a control method applied to UE to generate UE-aiding information in accordance with some embodiments of the present invention. As shown in FIG. 4, the UE may be a smart phone, but the present invention is not limited thereto. The UE monitors if any application is running at the UE (step S400), and detects if there is any new application activity (step S402). If there is no new application activity, the UE checks if any original application ends (step S404). If the original application ends, the UE checks if all applications end (step S406). If some applications do not end, the UE checks data rate requirement or latency requirement of all active applications (step S408). After that, the UE merges data rate requirement and/or latency requirement of all active applications to obtain a final requirement (step S410). Then, the UE checks the final requirement (step S412). If any application has high data rate requirement, the final requirement may be “data rate 1st” (step S420), else if any application has mid data rate requirement, the final requirement may be “balance” (step S418), else the final requirement may be “low power 1st” (step S416). The UE checks the final requirement and sets current UE power consumption requirement to “low power 1st”, “balance” or “data rate 1st”.

Furthermore, if there is new application activity, the UE checks data rate requirement or latency requirement of all active applications (step S408). If no original application ends in step S404, the UE remains current UE power consumption (application) requirement (step S414). If all applications end in step S406, the UE power consumption requirement to low power 1st.

Table 3 shows UE-aiding information to the base station. In order to simplify the base station design, UE can convert requirements several requirement levels as Table 3, and sent the requirements by UE-aiding information.

TABLE 3

| | Data Rate | Latency |
|---|---|---|
| Application | Requirement | Requirement |
| Messenger | Low power 1st | Low power 1st |
| Gaming | Low power 1st | Low latency 1st |
| Cloud Gaming | Data rate 1st | Low latency 1st |
| 240p video conference | Low power 1st | Low latency 1st |
| 720p video streaming | Balance | Low power 1st |
| 4K video streaming | Data rate 1st | Low power 1st |

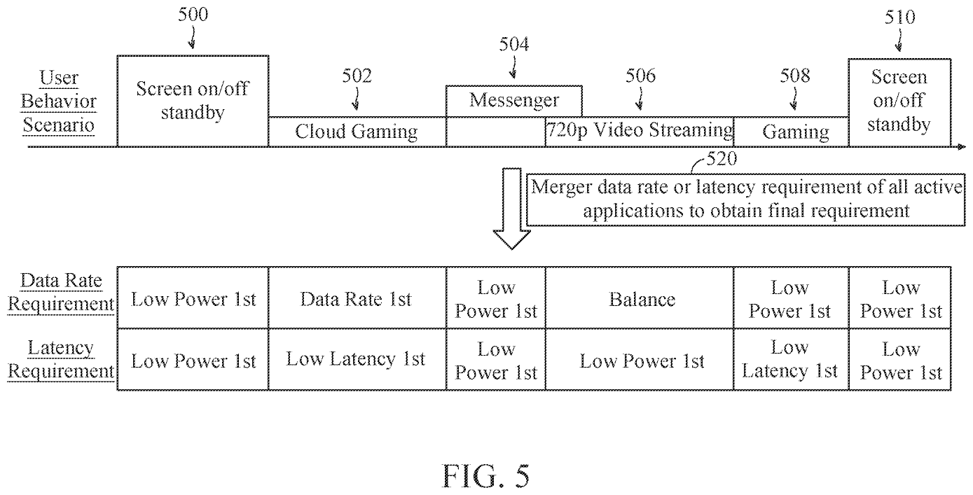

FIG. 5 is a schematic diagram of an operation of the UE for optimizing power consumption by application scenarios detection in accordance with some embodiments of the present invention. As shown in FIG. 5, in a scenario 500, the UE is in a screen on/off standby mode. The UE is able to convert the power consumption requirements to multiple levels as Table 3 to get “low power 1st” in data rate requirement and “low power 1st” in latency requirement. In a scenario 502, the UE executes the cloud gaming. The data rate requirement is about 25 Mbps, the cloud gaming is sensitive to the latency, the latency requirement is less than 70 ms˜100 ms per round trip. The UE is able to convert the power consumption requirements to multiple levels as Table 3 to get “data rate 1st” in data rate requirement and “low latency 1st” in latency requirement. The UE sends the power consumption requirements to the base station by UE-aiding information.

As shown in FIG. 5, in a scenario 504, when the UE leave cloud gaming and executes the messenger, the data rate requirement is lower than 1 Mbps, the messenger is not sensitive to the latency. The UE is able to convert the power consumption requirements to multiple levels as Table 3 to get “low power 1st” in data rate requirement and “low power 1st” in latency requirement. In a scenario 506, the UE executes the 720p video streaming, the data rate requirement is lower than 5 Mbps, the 720p video streaming is not sensitive to the latency. The UE is able to convert the power consumption requirements to multiple levels as Table 3 to get “balance” in data rate requirement and “low power 1st” in latency requirement. In a scenario 508, the UE executes the gaming, the data rate requirement is lower than 1 Mbps, the gaming is sensitive to the latency, the latency requirement is less than 70 ms˜100 ms per round trip. The UE is able to convert the power consumption requirements to multiple levels as Table 3 to get “low power 1st” in data rate requirement and “low latency 1st” in latency requirement. In a scenario 510, the UE is back to the screen on/off standby mode. The UE is able to convert the power consumption requirements to multiple levels as Table 3 to get “low power 1st” in data rate requirement and “low power 1st” in latency requirement. In some embodiments, the UE is able to executes an operation 520 to merge data rate requirement and/or latency requirement of all active applications to get a final requirement, which is the same as step S410 in FIG. 4.

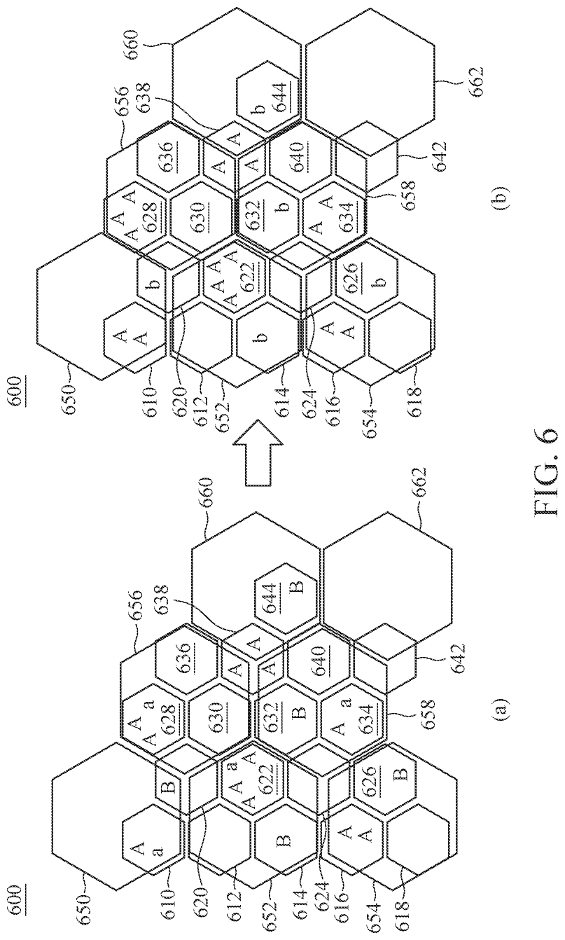

FIG. 6 is a schematic diagram of reducing the number of active component carriers and reducing an active bandwidth by the control method in FIGS. 1, 2 and 4 in accordance with some embodiments of the present invention. As shown in FIG. 6, a mobile network 600 includes a cell 610, a cell 612, a cell 614, a cell 616, a cell 618, a cell 620, a cell 622, a cell 624, a cell 626, a cell 628, a cell 630, a cell 632, a cell 634, a cell 636, a cell 638, a cell 640, a cell 642, and a cell 644. The cells 610˜644 are wide-bandwidth cells. The mobile network 600 further includes a cell 650, a cell 652, a cell 654, a cell 656, a cell 658, a cell 660 and a cell 662. The cells 650˜662 are narrow-bandwidth cells. In some embodiments, the cells 610˜644 are overlap with the cells 650˜662, but the present invention is not limited thereto. The symbol “A” in the cells means the UE with high data rate requirement using wide bandwidth. The symbol “B” in the cells means the UE with low data rate requirement using wide bandwidth. The symbol “a” in the cells means the UE with high data rate requirement using narrow bandwidth. The symbol “b” in the cells means the UE with low data rate requirement using narrow bandwidth.

For example, one UE having high data rate requirement is located in the cell 610, and one UE having high data rate requirement is located in the cell 650. One UE having low data rate requirement is located in the cell 614. Two UEs having high data rate requirement is located in the cell 616. One UE having low data rate requirement is located in the cell 620. Three UEs having high data rate requirement is located in the cell 622, and one UE having high data rate requirement is located in the cell 652. One UE having low data rate requirement is located in the cell 626. Two UEs having high data rate requirement is located in the cell 628, and one UE having high data rate requirement is located in the cell 656. One UE having low data rate requirement is located in the cell 632. One UE having high data rate requirement is located in the cell 634, and one UE having high data rate requirement is located in the cell 658. Three UEs having high data rate requirement is located in the cell 638. One UE having low data rate requirement is located in the cell 644.

In some embodiments, the mobile network 600 can identify UE's application requirement via UE-aiding information. The mobile network 600 can dynamically turn on or off the cells to provide best fit and low power to the UE. The mobile network 600 can move the UEs having low data rate requirement to the narrow-bandwidth cells, such as the cells 650˜662 in FIG. 6, and move the UEs having high data rate requirement to the wide-bandwidth cells, such as the cells 610˜644 in FIG. 6. For example, the UE having high data rate requirement, which is originally in the cell 650, is configured to the cell 610 by the mobile network 600. The UE having high data rate requirement, which is originally in the cell 652, is configured to the cell 622 by the mobile network 600. The UE having high data rate requirement, which is originally in the cell 656, is configured to the cell 628 by the mobile network 600. Similarly, the UE having high data rate requirement, which is originally in the cell 658, is configured to the cell 634 by the mobile network 600.

Furthermore, the UE having low data rate requirement, which is originally in the cell 614, is configured to the cell 652 by the mobile network 600. The UE having low data rate requirement, which is originally in the cell 620, is configured to the cell 650 by the mobile network 600. The UE having low data rate requirements, which is originally in the cell 626, is configured to the cell 654 by the mobile network 600. The UE having low data rate requirement, which is originally in the cell 632, is configured to the cell 658 by the mobile network 600. Similarly, the UE having low data rate requirement, which is originally in the cell 644, is configured to the cell 660 by the mobile network 600. Once the UEs originally in the wide-bandwidth cells are configured to the narrow-bandwidth cells, the active bandwidth are equivalently reduced.

After that, since there is no any UEs in the cells 612, 614, 618, 620, 624, 630, 632, 636, 640, 642 and 644, the mobile network 600 is able to turn off the cells 612, 614, 618, 620, 624, 630, 632, 636, 640, 642 and 644 for power saving. In some embodiments, once the cells 612, 614, 618, 620, 624, 630, 632, 636, 640, 642 and 644 are turned off, the number of active component carriers is equivalently reduced. It is noted that a cell is formed by UE connecting with a base station through a component carrier. Therefore, once the number of active cells is reduced, the number of active component carriers is also reduced.

In some embodiments, after receiving the UE-aiding information from the UEs, the mobile network 600 is able to set a low power transmission parameter to provide best fit and low power to the UEs instead of keeping VIP users in high power consumption parameter to over-preserve capability, which can save power. For example, the mobile network 600 is able to move the VIP users having low data rate requirement to narrow-bandwidth cells. In some embodiments, after receiving the UE-aiding information from the UEs, the mobile network 600 is able to support more VIP users. That is, the mobile network 600 (or the base station in the mobile network 600) can save resource for the VIP users having low data rate requirement, thus provide more VIP users service in one cell.

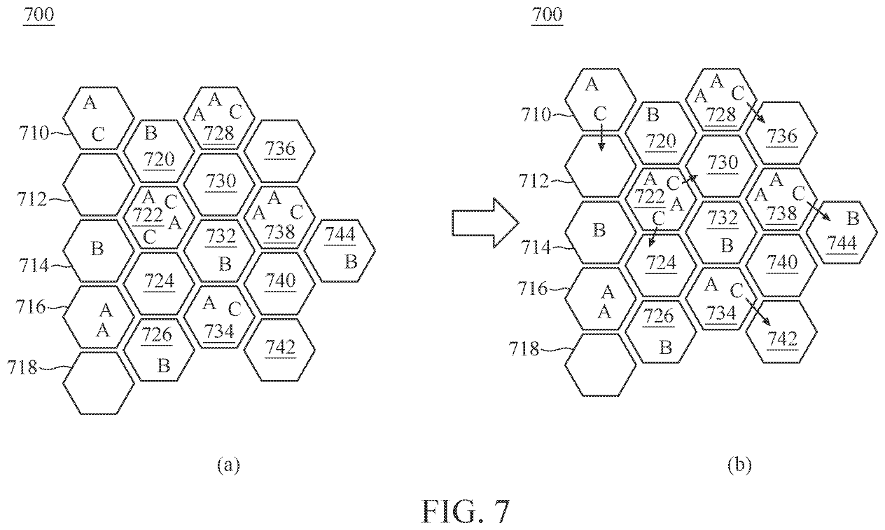

FIG. 7 is a schematic diagram of moving UE closed to cell boundary to another cell by the control method in FIG. 2 in accordance with some embodiments of the present invention. As shown in FIG. 7, a mobile network 700 includes a cell 710, a cell 712, a cell 714, a cell 716, a cell 718, a cell 720, a cell 722, a cell 724, a cell 726, a cell 728, a cell 730, a cell 732, a cell 734, a cell 736, a cell 738, a cell 740, a cell 742, and a cell 744. In some embodiments, the cells 710˜744 are wide-bandwidth cells, but the present invention is not limited thereto. The symbol “A” in the cells means the UE with high data rate requirement. The symbol “B” in the cells means the UE with low data rate requirement. The symbol “C” in the cells means the UE is closed to the cell boundary.

For example, one UE having high data rate requirement is located in the cell 710, and one UE is located in the cell 710 closed to the cell boundary between the cells 710 and 712. One UE having low data rate requirement is located in the cell 714. Two UEs having high data rate requirement are located in the cell 716. One UE having low data rate requirement is located in the cell 720. Two UEs having high data rate requirement are located in the cell 722, and another two UEs are located in the cell 722 closed to the cell boundary. One UE having low data rate requirement is located in the cell 726. Two UEs having high data rate requirement are located in the cell 728, and one UE is located in the cell 728 closed to the cell boundary between the cells 728 and 736. One UE having low data rate requirement is located in the cell 732. One UE having high data rate requirement is located in the cell 734, and one UE is located in the cell 734 closed to the cell boundary between the cells 734 and 742. Two UEs having high data rate requirement are located in the cell 738, and one UE is located in the cell 738 closed to the cell boundary between the cells 738 and 744. One UE having low data rate requirement is located in the cell 744.

In some embodiments, after receiving the UE-aiding information from the UEs, the mobile network 700 is able to move the UEs closed to the cell boundary to the adjacent cell for load balance. For example, the UE original closed to the cell boundary in the cell 710 is configured to the cell 712. The UEs original closed to the cell boundary in the cell 722 are configured to the cells 724 and 730 respectively. The UE original closed to the cell boundary in the cell 728 is configured to the cell 736. The UE original closed to the cell boundary in the cell 734 is configured to the cell 742. The UE original closed to the cell boundary in the cell 738 is configured to the cell 734. Since the mobile network 700 knows user information more clearly via the UE-aiding information, the load balance mechanism performed by the mobile network 700 can be wiser.

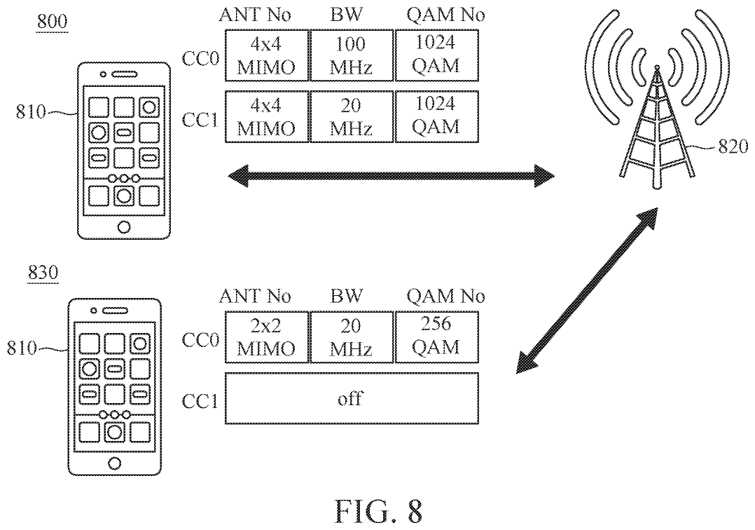

FIG. 8 is a schematic diagram of configuring the transmission parameter to the UE based on the UE-aiding information by the control method in FIGS. 1, 2 and 4 in accordance with some embodiments of the present invention. As shown in FIG. 8, in a scenario 800 with high data rate requirements, UE 810 is able to connect with a base station 820 by control signaling. The control-signaling may be a radio resource control (RRC) signaling, a physical layer (L1)/data link layer (L2) control signaling, or both. The base station 820 receives the UE-aiding information from the UE 810. The UE 810 is able to connect with the base station 820 by using a component carrier CC0 and a component carrier CC1. For the component carrier CC0, the number of active antennas used for Multi-input Multi-output (MIMO) is 4×4, the active bandwidth is 100 MHz, and the format of a modulation scheme is 1024-QAM. For the component carrier CC1, the number of active antennas used for MIMO is 4×4, the active bandwidth is 20 MHz, and the format of a modulation scheme is 1024-QAM. In some embodiments, the format of the modulation scheme may include 1024-QAM, 256-QAM, 64-QAM, and 16-QAM, but the present invention is not limited thereto.

In a scenario 830 with low data rate requirements, UE 810 is able to connect with a base station 820 by control signaling, and the base station 820 receives the UE-aiding information from the UE 810. Due to the low data rate requirements, the base station 820 is able to turn off the component carrier CC1, and only remain the component carrier CC0 for transmission. That is, the number of active component carriers is reduced. Furthermore, for component carrier CC0, the number of active antennas used for MIMO is reduced from 4×4 to 2×2, the active bandwidth is reduced from 100 MHz to 20 MHz, and the format of a modulation scheme is lower from 1024-QAM to 256-QAM. In other words, the format of the modulation scheme is changed from higher modulated QAM to lower modulated QAM for power saving by the base station 820 based on the real time UE-aiding information from the UE 810.

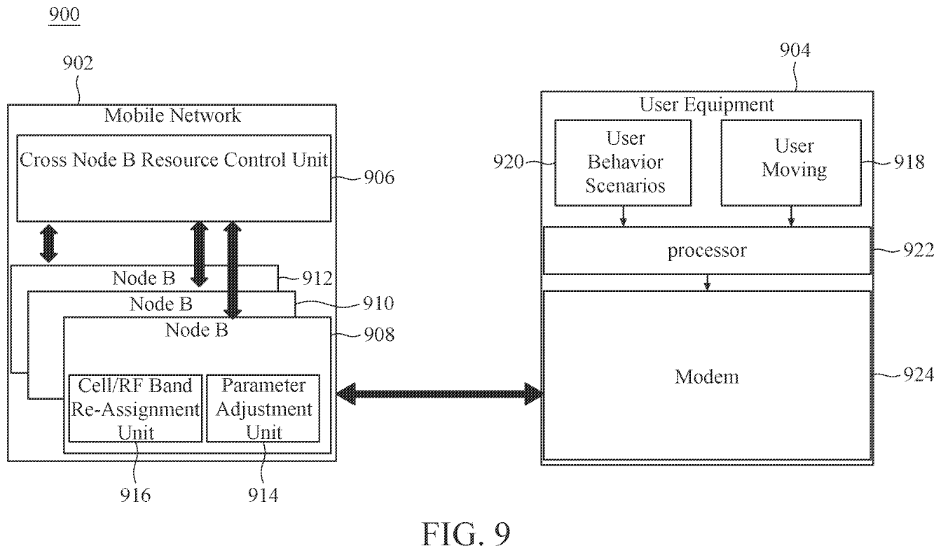

FIG. 9 is a block diagram of a communication system 900 applying the control method in FIGS. 1, 2 and 4 in accordance with some embodiments of the present invention. As shown in FIG. 9, the communication system 900 includes a mobile network 902 and user equipment (UE) 904. The mobile network 902 is able to connect with the UE 904 by control signaling. In some embodiments, the mobile network 902 includes a cross node B resource control unit 906, and a plurality of base stations (so called node B), such as base stations 908, 910 and 912. Each base station 908, 910 and 912 includes a parameter adjustment unit 914 and a cell/RF band re-assignment unit 916. In some embodiments, the cross node B resource control unit 506 is able to select the base station to connect with the UE 904 based on geographical location and priority of the UE 904. For example, when the base station 908 is selected to connect with the UE 904, the base station 908 receives UE-aiding information from the UE 904. In some embodiments, the UE-aiding information may include a power consumption requirement. The power consumption requirement includes at least one of the data rate requirement and the latency requirement, for the UE to execute one or more applications.

After that, the parameter adjustment unit 914 configures one or more transmission parameters to the UE 904 for power saving to meet a best-fit operation mode. In some embodiments for power saving, for example, the parameter adjustment unit 914 may reduce the number of active antennas used for Multi-input Multi-output (MIMO), reduce the number of active component carriers, reduce the active bandwidth, change the format of the modulation scheme, change the scheduling request period, and change a radio access technology (RAT), between the mobile network 902 and the UE 904. The cell/RF band re-assignment unit 916 is able to configure the UE 904 to an adjacent cell for handover.

In some embodiments, the UE 904 includes a processor922 and a modem 924. The processor922 collects user behavior scenarios 920 and user moving 918 from the UE 904. In some embodiments, the user behavior scenarios 920 may include the power consumption requirement including the data rate requirement and the latency requirement for UE 904 to execute one or more applications. For example, the processor 922 executes a function of scenario reporting based on the user behavior scenarios 920 and the user moving 918. The processor 922 determines the power consumption requirement of the UE based on the power consumption requirement of one or more applications currently executed on the UE. The user moving 918 may be detected by the sensor and Doppler radar (now shown) in the UE 904. After that, the processor922 combines user behavior scenarios 920 and user moving 918 into UE-aiding information. The modem 924 sends the UE-aiding information to the base station 908 in the mobile network 902.

In some embodiments, the base station 908 queries the UE 904 having UE-aiding information with transmission parameters, such as the number of antennas and component carriers, the transmission bandwidth, the modulation scheme, the scheduling request period and the radio access technology (RAT). The UE 904 feedbacks the base station 908 with the UE-aiding information based on user experience (UX) requirement. After that, the base station 908 reaches power saving and load-balance target based on the UE-aiding information from the UE 904. In some embodiments, the UE 904 self-reports the base station 908 with the UE-aiding information based on the UX requirement. The base station 908 reconfigures the transmission parameters for power saving and feedbacks to the UE 904.

In some embodiments, the network 902 sets a target network configuration for network power saving. The UE 904 responses its evaluation results to the network 902 via UE-aiding information with suggested physical resource for its service. Finally, the network 902 takes the UE-aiding information into account and adjust the final physical setting of the network.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, applied to a base station, comprising:
receiving UE-aiding information from a user equipment (UE), wherein the UE-aiding information comprises a power consumption requirement of the UE; and
configuring one or more transmission parameters to the UE based on the UE-aiding information.

2. The method as claimed in claim 1, wherein the power consumption requirement comprises at least one of a data rate requirement and a latency requirement.

3. The method as claimed in claim 2, wherein the data rate requirement is represented by the ranking of multiple levels of the data rate requirement, and the latency requirement is represented by the ranking of multiple levels of the latency requirement.

4. The method as claimed in claim 1, wherein the one or more transmission parameters comprises at least one of:
the number of antennas used for Multi-input Multi-output (MIMO);
the number of component carriers;
a transmission bandwidth;
a modulation scheme;
a scheduling request period; and
a radio access technology (RAT).

5. The method as claimed in claim 1, further comprising:
sending a requirement-query message to the UE;
wherein the UE-aiding information is transmitted by the UE in response to the requirement-query message.

6. The method as claimed in claim 1, wherein the step of configuring the one or more transmission parameters to the UE base on the UE-aiding information comprises:
determining the one or more transmission parameters for the UE based on the UE-aiding information; and
configuring the one or more transmission parameters to the UE.

7. The method as claimed in claim 6, wherein the power consumption requirement comprises a data rate requirement and a latency requirement and the step of determining the one or more transmission parameters for the UE based on the UE-aiding information comprises:
determining a first value for a transmission parameter based on the data rate requirement;
determining a second value for the transmission parameter based on the latency requirement; and
selecting one of the first value and the second value for the transmission parameter fulfilling both the data rate requirement and the latency requirement as a value of the transmission parameter for the UE.

8. The method as claimed in claim 6, further comprising:
detecting if a current cell where the UE is located supports the one or more transmission parameters determined based on the UE-aiding information.

9. The method as claimed in claim 8, further comprising:
asking the UE to handover to another cell supporting the one or more determined transmission parameters determined based on the UE-aiding information.

10. The control method as claimed in claim 8, further comprising:
detecting if there is a neighbor cell supporting a preferred RAT than the current cell where the UE is located if the current cell where the UE is located is detected as supporting the one or more transmission parameters determined based on the UE-aiding information; and
asking the UE to handover to the neighbor cell based on the neighbor cell being detected as supporting the preferred RAT, wherein the neighbor cell supports the one or more determined transmission parameters.

11. A method applied to a user equipment (UE), comprising:
transmitting UE-aiding information to a base station, wherein the UE-aiding information comprises a power consumption requirement of the UE;
receiving one or more transmission parameters from the base station, wherein the transmission parameter is configured by the base station based on the UE-aiding information; and
configuring the UE according to the one or more transmission parameters.

12. The method as claimed in claim 11, further comprising:
determining the power consumption requirement of the UE based on one or more power consumption requirement of one or more applications currently executed on the UE.

13. The method as claimed in claim 11, wherein the power consumption requirement comprises at least one of a data rate requirement and a latency requirement.

14. The method as claimed in claim 13, wherein the data rate requirement is represented by the ranking of multiple levels of the data rate requirement, and the latency requirement is represented by the ranking of multiple levels of the latency requirement.

15. The method as claimed in claim 11, wherein the one or more transmission parameters comprises at least one of:
the number of antennas used for Multi-input Multi-output (MIMO);
the number of component carriers;
a transmission bandwidth;
a modulation scheme;
a scheduling request period; and
a radio access technology (RAT).

16. A user equipment (UE), comprising:
a modem, configured to transmit UE-aiding information to a base station, wherein the UE-aiding information comprises a power consumption requirement of the UE, and receive one or more transmission parameters from the base station, wherein the transmission parameter is configured by the base station based on the UE-aiding information; and
a processor, configured to configure the UE according to the one or more transmission parameters.

17. The UE as claimed in claim 16, wherein the processor determines the power consumption requirement of the UE based on one or more power consumption requirement of one or more applications currently executed on the UE.

18. The UE as claimed in claim 16, wherein the power consumption requirement comprises at least one of a data rate requirement and a latency requirement.

19. The UE as claimed in claim 18, wherein the data rate requirement is represented by the ranking of multiple levels of the data rate requirement, and the latency requirement is represented by the ranking of multiple levels of the latency requirement.

20. The UE as claimed in claim 16, wherein the one or more transmission parameters comprises at least one of:
the number of antennas used for Multi-input Multi-output (MIMO);
the number of component carriers;
a transmission bandwidth;
a modulation scheme;
a scheduling request period; and
a radio access technology (RAT).
